(19) United States
(12) Patent Application Publication
(10) Pub. No.: US 2007/0228191 A1
(43) Pub. Date: Oct. 4, 2007

(54) Cooled nozzle assembly for urea/water injection

(75) Inventors: Michael P. Harmon, Dunlap, IL (US); Cho Y. Liang, Henderson, NV (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/643,897

(22) Filed: Dec. 22, 2006

Related U.S. Application Data
(63) Continuation-in-part of application No. 11/393,944, filed on Mar. 31, 2006.

(51) Int. Cl. F02M 47/02; F02M 63/00; F02M 51/00

(52) U.S. Cl. 239/533.2; 239/89; 239/585.5

(57) ABSTRACT

A fluid-injecting system includes a nozzle assembly which includes a housing defining an outlet cooling passage, an outlet control passage, at least one inlet supply passageway, and an injection orifice. The nozzle assembly also includes a shaft disposed within the housing and movable between a closed position and an open position. The fluid-injecting system further includes a first valve in fluid communication with the nozzle assembly configured to regulate the supply of a fluid through the at least one inlet passageway and a second valve in fluid communication with the nozzle assembly to regulate a flow of fluid through the outlet passageway.

### RELATED APPLICATIONS

This application is a continuation-in-part of U.S. patent application Ser. No. 11/393,944 by Michael P. Harmon, et al., filed Mar. 31, 2006, the entire disclosure of which is incorporated herein by reference.

### TECHNICAL FIELD

The present disclosure is directed to a nozzle assembly and, more particularly, to a cooled nozzle assembly utilized for injection of a urea/water solution.

### BACKGROUND

Engines, including diesel engines, gasoline engines, natural gas engines, and other engines known in the art, may exhaust a complex mixture of air pollutants. The air pollutants may be composed of both gaseous and solid material, such as, for example, particulate matter. Gaseous material may include, among other things, the oxides of nitrogen (NOx). Particulate matter may include ash and unburned carbon particles called soot.

Due to increased environmental concerns, some engine manufacturers have developed systems to treat engine exhaust after it leaves the engine. Some of these systems employ exhaust treatment devices, such as particulate traps or catalytic reduction systems, to remove particulate matter from the exhaust flow. A particulate trap may include filter material designed to capture particulate matter. After an extended period of use, however, the filter material may become partially saturated with particulate matter, thereby hindering the filter material's ability to capture particulates. In addition, a saturated particulate filter may cause an increase in exhaust backpressure, which can negatively affect engine performance. Another process used to treat engine exhaust is selective catalytic reduction (SCR). SCR is a process in which a gaseous or liquid reductant (most commonly urea) is added to the exhaust gas stream of an engine and is further absorbed onto a catalyst. The reductant reacts with NOx in the exhaust gas to form H₂O and N₂.

Both particulate regeneration devices and selective catalytic reduction systems utilize injectors as an integral part of their operation. In a particulate regeneration device, the collected particulate matter may be removed from the filter material through a process called regeneration. Particulate regeneration devices use injectors to inject a fuel into the exhaust stream, which then may be ignited to increase the temperature of the particulate matter above its combustion temperature, thereby burning away the collected particulate matter. SCR uses injectors to introduce a reductant fluid into the exhaust stream, causing a reaction with a catalyst to form H₂O and N₂. In either situation, the injectors must be able to withstand high temperatures while maintaining functionality.

A particulate regeneration system using an injector for regeneration is disclosed by U.S. Pat. No. 4,651,524, issued to Brighton on Mar. 24, 1987 (“the '524 patent”). The '524 patent discloses an exhaust treatment system configured to increase the temperature of exhaust gases with a burner by periodically oxidizing trapped particulate matter. This increase in temperature is accomplished by way of a flame means for igniting particulate matter collected in an upstream or inlet end of the particulate filter. The flame means includes an injector nozzle that casts a spray or mist of fuel into an associated combustion chamber.

While the system of the '524 patent may utilize an injector to increase the temperature of the particulate trap, the regeneration device, specifically the injector portion, of the '524 patent may have a decreased life span. When operating the flame means at the high temperatures required by particulate regeneration, residual fuel left in the injector portion between regeneration means heats up. Without a way to actively cool the components of the injection system, the residual fuel in the injector may coke, causing the injector to clog over time. Because the '524 patent does not provide a self-cooling feature, the flame means may be unable to provide various modes of operation where fluid still circulates within the injector to provide cooling flow even when an injection event is not taking place. In addition, the '524 patent may not be able to control a flow and pressure of fluid into the injector.

The disclosed cooled nozzle assembly is directed toward overcoming one or more of the problems set forth above.

### SUMMARY OF THE INVENTION

In one exemplary embodiment of the present disclosure, a fluid-injecting system includes a nozzle assembly, a first valve, and a second valve. The nozzle assembly includes a housing defining an outlet cooling passage, an outlet control passage, at least one inlet supply passageway, and an injection orifice. The nozzle also includes a shaft disposed within the housing and movable between a closed position at which fluid is prevented from exiting via the orifice and an open position at which fluid passes through the orifice. The first valve is in fluid communication with the nozzle assembly and configured to regulate the supply of a fluid through the at least one inlet fluid passageway. The second valve is in fluid communication with the nozzle assembly and configured to regulate the flow of fluid through the first outlet fluid passageway.

In another exemplary embodiment of the present disclosure, an exhaust system includes an exhaust housing, a catalyst substrate, and a fluid-injecting system. The fluid-injecting system includes a nozzle assembly, a first valve, and a second valve. The nozzle assembly includes a housing defining an outlet cooling passage, an outlet control passage, at least one inlet supply passageway, and an injection orifice. The nozzle also includes a shaft disposed within the housing and movable between a closed position at which fluid is prevented from exiting via the orifice, and an open position at which fluid passes through the orifice. The first valve is in fluid communication with the nozzle assembly and configured to regulate the supply of a fluid through the at least one inlet fluid passageway. The second valve is in fluid communication with the nozzle assembly and configured to regulate the flow of fluid through the first outlet fluid passageway.

In still another embodiment of the present disclosure, a method of injecting a reductant into a catalytic reduction system includes supplying the reductant to a nozzle assembly via a first valve. The method also includes cooling a portion of the nozzle assembly by directing a fluid to a chamber of the nozzle assembly when a shaft of the nozzle assembly is in an open position and directing a portion of the fluid from a central portion of the chamber to a bypass passage of the shaft, when the shaft is in the open position.

### BRIEF DESCRIPTION OF THE DRAWINGS

FIG. 1 is a diagrammatic illustration of an exemplary disclosed fluid-injecting system;

FIG. 2 is a diagrammatic illustration of an exemplary disclosed constituent reduction system; and

FIG. 3 is an end view of an exemplary disclosed nozzle assembly for use with the fluid injecting system of FIG. 1.

### DETAILED DESCRIPTION

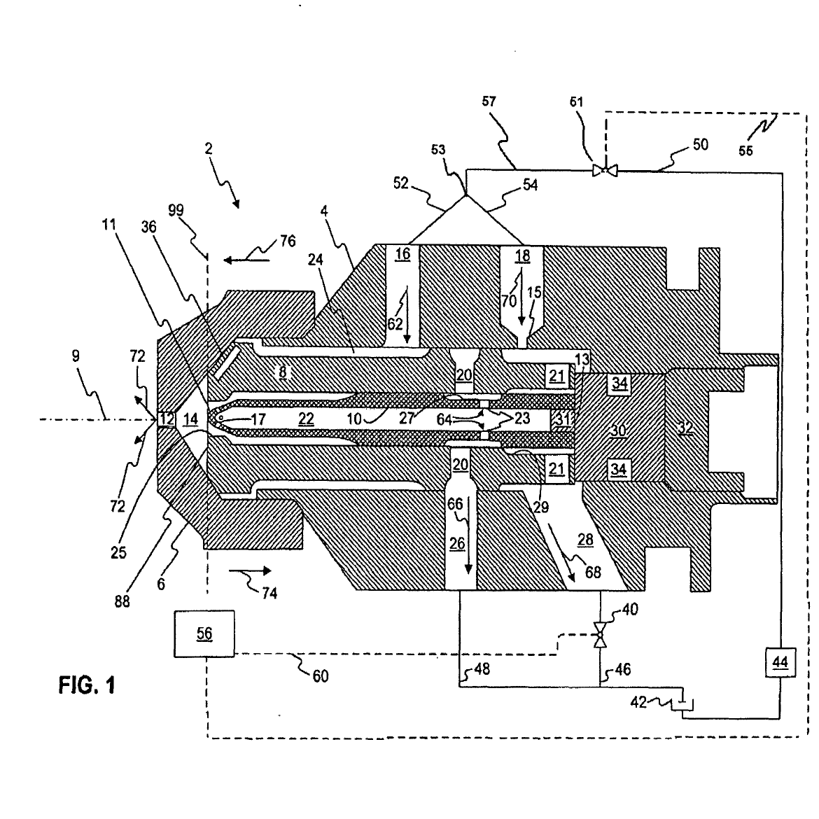

As shown in FIG. 1, a fluid-injecting system includes a nozzle assembly 2. The nozzle assembly 2 includes a housing 4, a cap 6, and a sleeve 8 disposed within a channel 24 of the housing 4. The nozzle assembly 2 further includes a shaft 10 movably disposed within the sleeve 8. The sleeve 8 abuts the cap 6 and a stop 30 of the nozzle assembly 2. The stop 30 and the sleeve 8 are secured against the cap 6 with a set screw 32.

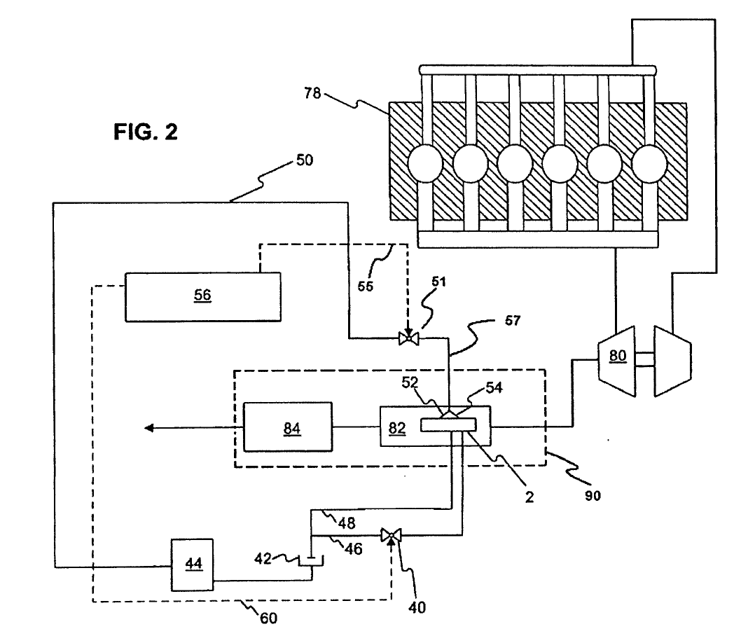

The housing 4 may be, for example, a manifold or any other like structure capable of supporting components of a nozzle assembly and assisting in forming a chamber 14 for swirling fluid to be injected by the nozzle assembly 2. As shown in FIG. 1, the cap 6, the sleeve 8, the shaft 10, the stop 30, and the set screw 32 may be at least partially supported by and/or connected to the housing 4. The housing 4 may be fabricated of any materials known in the art capable of withstanding exhaust system temperatures. Such materials may include, for example, platinum, steel, aluminum, and/or any alloys thereof. In addition, the housing 4 may be made of cast iron or any other cast material. As will be discussed below with respect to FIG. 2, the housing 4 and/or other components of the nozzle assembly 2 may be sized and/or otherwise configured to be mounted within a fluid-injecting system 82.

The housing 4 may define a first fluid passage 18 and a second fluid passage 16. First fluid passage 18 may fluidly connected with a channel 54 and second fluid passage 16 may be fluidly connected to a channel 52. Channels 52 and 54 may be joined at a location proximate the housing 4 on a fluid line 57. The housing 4 may further define a third fluid passage 28 and a fourth fluid passage 26. As will be described in greater detail below, the third fluid passage 28 may be fluidly connected to the first fluid passage 18 via radial passages in, for example, the sleeve 8. In addition, each of the fluid passages 16, 18, 26, 28 may be fluidly connected to the channel 24 of the housing 4. As shown in FIG. 1, a portion of the first fluid passage 18 may define a conical restriction 15 proximate an interface between the first fluid passage 18 and a portion of the sleeve 8. This conical restriction 15 may, for example, have a smaller diameter than a diameter of the third fluid passage 28.

The cap 6 may be connected to the housing 4 in any conventional way so as to form a fluid seal therebetween. For example, the cap 6 may include male threads, and the housing 4 may include corresponding female threads configured to form a fluid seal when pressurized fluid is contained within the housing 4 and/or the cap 6. The fluid seal may be capable of withstanding fluid pressures in excess of, for example, 250 psi during operation of the nozzle assembly 2. The cap 6 may be made from, for example, any of the materials discussed above with respect to the housing 4. As shown in FIG. 1, the cap 6 may define an orifice 12. The orifice 12 may be sized, angled, and/or otherwise configured to inject a conical-shaped flow of fluid into, for example, the fluid-injecting system 82 (FIG. 2). The cap 6 may assist in defining the chamber 14 proximate the shaft 10, and the chamber 14 may also be sized, shaped, and/or otherwise configured to assist in injecting the conical flow of fluid.

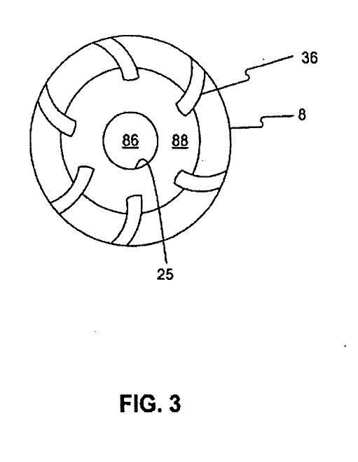

The sleeve 8 may be substantially cylindrical and substantially hollow. The sleeve 8 may be disposed adjacent to an inner surface of the cap 6 and may be made of any of the metals discussed above with respect to the housing 4. The sleeve 8 may define a plurality of slots 36 in fluid communication with the channel 24 of the housing 4 and the chamber 14. The plurality of slots 36 may be disposed at any desirable angle to assist in injecting fluid into the chamber 14 at an angle relative to a longitudinal axis 9 of the shaft 10 and relative to a radial axis 99 of the sleeve 8. As shown in FIG. 3, the sleeve 8 may define a front face 88 and a channel 86. In an exemplary embodiment, the front face 88 may lie along the radial axis 99 and may be substantially perpendicular to the longitudinal axis 9 (FIG. 1). The slots 36 may be substantially straight or, alternatively, may be curved. Although the sleeve 8 shown in FIG. 3 includes six slots 36 (only one of which is illustrated in FIG. 1), it is understood that in other exemplary embodiments, the sleeve 8 may include more or less than six slots 36. The channel 86 may be sized and/or otherwise configured to receive the shaft 10 movably disposed therein.

Referring again to FIG. 1, the sleeve 8 may also define a first radial passage 21 and a second radial passage 20. The first radial passage 21 may assist in fluidly connecting the first fluid passage 18 to the third fluid passage 28. In addition, the first radial passage 21 may be configured to supply fluid between an end 13 of the shaft 10 and, for example, the stop 30. The first radial passage 21 may have a larger diameter and/or cross sectional area than the diameter of the conical restriction 15 of the first fluid passage 18. As will be described in greater detail below, the delivery of fluid between, for example, the end 13 of the shaft 10 and the stop 30 may assist in moving the shaft 10 within the sleeve 8.

It is understood that the first and second radial passages 21, 20 may be channels that are milled, drilled, cut, and/or otherwise formed in the sleeve 8. The first and second radial passages 21, 20 may extend substantially around a perimeter or circumference of the sleeve 8 and may be formed into a wall of the sleeve 8 or on a surface of the sleeve 8. Thus, although shown as notches in the cross-sectional view of FIG. 1, it is understood that fluid may be contained completely within the first and second radial passages 21, 20 when passing from, for example, the first fluid passage 18 to the third fluid passage 28. As shown in FIG. 1, the sleeve 8 may include a larger inner diameter portion 29 proximate the end 13 and the first radial passage 21 may be configured to direct fluid to the larger inner diameter portion 29. Alternatively, in an exemplary embodiment (not shown), the shaft 10 may include a smaller diameter portion proximate the end 13 and the first radial passage 21 may be configured to direct fluid to the smaller diameter portion.

The shaft 10 may be substantially cylindrical and may have a substantially cone-shaped tip 11. A portion of the shaft 10 may taper towards the tip 11. The shaft 10 may be movably disposed within the sleeve 8 and may have a first or open position (shown in FIG. 1) in which the shaft 10 abuts the stop 30 and the chamber 14 is at its maximum volume. The shaft 10 may also have a second or closed position (not shown) at which the tip 11 may engage the orifice 12 of the cap 6, and the shaft 10 may substantially fluidly seal the orifice 12. The shaft 10 may move in the direction of arrow 76 when transitioning from the open position to the closed position. Conversely, the shaft 10 may move in the direction of arrow 74 when transitioning from the closed position to the open position shown in FIG. 1. As will be described in greater detail below, such movement may result from differences in fluid pressure within certain portions of, for example, the sleeve 8 and/or the housing 4. The sleeve 8 may define a reduced inner diameter portion 25 proximate the tip 11, and the tip 11 may pass through the reduced inner diameter portion 25 when the shaft 10 transitions from the open position to the closed position.

The shaft 10 may be substantially hollow and may define a bypass passage 22 therein. The shaft 10 may also include a plug 31 disposed proximate the end 13 and forming a substantially fluid seal at the end 13. The shaft 10 may further define at least one feed hole 17 proximate the tip 11. The feed holes 17 may assist in fluidly connecting, for example, the chamber 14 to the bypass passage 22. In an exemplary embodiment, the shaft 10 may define four feed holes 17 configured to direct fluid from a central portion of the chamber 14 to the bypass passage 22.

It is understood that the bypass passage 22 may be fluidly connected to, for example, the plurality of slots 36, the chamber 14, and the second radial passage 20 in both the open and the closed position. The feed holes 17 may be disposed about the tip 11 such that when the shaft 10 is in the closed position, fluid entering the chamber 14 through the slots 36 may pass through the feed holes 17 and into the bypass passage 22. The shaft 10 may also define a plurality of escape channels 23 configured to fluidly connect the bypass passage 22 with the second radial passage 20. It is understood that the bypass passage 22, the feed holes 17, and the escape channels 23 may be drilled, milled, cut, and/or otherwise formed into the shaft 10. The bypass passage 22, the feed holes 17, and the escape channels 23 may be disposed at any angle relative to the longitudinal axis 9, and may have any diameter useful in directing a flow of fluid. In an exemplary embodiment, the shaft 10 may also define an annulus 27 or other conventional indentation on an outer surface of the shaft 10. The annulus 27 may be in fluid communication with the escape channels 23 and may assist in fluidly connecting the escape channels 23 to the first radial passage 20.

The stop 30 may be, for example, any conventional mechanical spacer. The stop 30 may be made from any of the metals discussed above with respect to the housing 4 and may be sized, shaped, and/or configured to secure the sleeve 8 tightly against, for example, the cap 6 when the set screw 32 is fully tightened. The stop 30 may be substantially noncompressible and may include at least one groove configured to accept a seal 34. The seal 34 may be configured to form a fluid seal between, for example, the housing 4 and the stop 30. In an exemplary embodiment, the seal 34 may be an o-ring made of any conventional plastic, rubber, polymer, or composite. Such materials may include, for example, Viton® or other fluoroelastomers. The seal 34 may be configured to form such a fluid seal when fluid pressures within the housing 4 exceed some predetermined pressure and the set screw 32 may assist in forming such a seal.

Multiple valves may be fluidly connected to the housing 4 to assist in controlling the flow of fluid therein. For example, a valve 40 may be fluidly connected to the third fluid passage 28, and a supply valve 51 may be fluidly connected to inlet passageway 53. The valves 40, 51 may be any type of controllable two-way valve known in the art. The valves 40, 51 may include an actuation device (not shown), such as, for example, a solenoid, to assist in variably regulating a flow of fluid there through. A portion of each valve 40, 51, such as, for example, the actuation device, may be electrically connected to a controller 56. The dotted control lines 55, 60 shown in FIG. 1 illustrate such a connection. The controller 56 may be, for example, an electronic control unit, a computer, and/or any other conventional data processor configured to control the position and/or functionality of valves 40, 51. The valves 40, 51, may also be fluidly connected to a tank 42 by fluid lines 46, 50, respectively. The fluid lines 46, 50 may be any conventional pipes, hoses, and/or other like structures configured to transmit pressurized fluid, and the fluid lines 46, 50 may be configured to transmit fluid to and from the valves 40, 51 at pressures in excess of 250 psi.

The tank 42 may be, for example, a reductant tank containing, for example, a urea/water mixture and may be connected to a conventional pressure source, such as a pump 44. The urea/water mixture may serve as a catalyst to reduce exhaust constituents, such as NOx, by interacting with the exhaust and a catalyst substrate 84 (referring to FIG. 2) to form nitrogen and water. Though this exemplary embodiment may utilize a urea/water mixture as the preferred reductant, it is also contemplated that other reductants known to reduce exhaust constituents may be used, such as ammonia, AdBlue®, etc.

The nozzle assembly 2 may be supplied with fluid drawn from tank 42. Specifically, tank 42 may be connected to the first fluid passageway 18 and the second fluid passageway 16 by way of the common supply passages 50, 57 and branching parallel channels 52, 54.

The pump 44 may be disposed within the common supply passage 50 and configured to draw fluid from the tank 42, pressurize the fluid, and direct the pressurized fluid to the supply valve 51 via the fluid line 50.

The valve 40 may be disposed between third fluid passage 28 and tank 42 to regulate a flow of fluid through the nozzle assembly 2. Specifically, the valve 40 may include a spring-biased proportional valve mechanism that is solenoid-actuated to move between a first position and a second position. In the first position, the valve 40 may be substantially open, relieving pressure on surface 13 and causing shaft 10 to move to the right in the direction of arrow 74, which may result in nozzle assembly 2 being in a mode of both self-cooling and injecting. Alternatively, in the second position, the valve 40 may be substantially closed, which may result in a buildup of pressure on surface 13, causing shaft 10 to move to the left in the direction of arrow 76. In such a configuration, the nozzle assembly 2 may be in a mode of cooling but not injecting.

The supply valve 51 may be disposed between pump 44 and channels 52, 54 to control a flow rate and/or pressure of the fluid to channels 52, 54. Specifically, the supply valve 51 may include a spring-biased proportional valve mechanism that is solenoid-actuated to move in a spectrum between a first position, at which fluid is allowed to flow into channels 52, 54 via the at least one inlet fluid passageway 53, and a second position, at which fluid flow is blocked from channels 52, 54. It is contemplated that the supply valve 51 may alternatively be hydraulically-actuated, mechanically-actuated, pneumatically-actuated, or actuated in any other suitable manner.

The supply valve 51 may comprise a pulsing valve to provide metered amounts of a pressurized fluid to nozzle assembly 2. Pulsing of valve 51 may consist of controller 56 opening and closing supply valve 51 for predetermined amounts of time to meter discrete amounts of fluid to nozzle assembly 2. For example, controller 56 may continuously alternate supply valve 51 between an open and closed position for equal periods of time, thus providing a supply of fluid to nozzle assembly 2 substantially one half of that provided by an open supply valve 51. This pulsing of supply valve 51 may provide shortened periods of high pressure injections. This may be advantageous over a partially open valve, which may provide longer or sustained periods of lower pressure injections. Since nozzle assembly 2 may require a minimum threshold injector pressure for efficient dispersal of a reductant, the pulsing of supply valve 51 may be preferred over a partially open valve.

Various engine operating conditions of power source 78 may call for different metered amounts to be provided to nozzle assembly 2 and injected via fluid-injecting system 82. For example, controller 56 may be provided with a signal indicative of a current concentration of exhaust constituents, such as NOx. In response, controller 56 may operate the supply valve 51 in such a way to provide a sufficient flow and pressure of fluid into the nozzle assembly 4. The sufficient flow and pressure may be enough to substantially react with most of the exhaust constituents, but not so much as to waste an amount of fluid. For example, in an engine operating condition producing a lower concentration of NOx, it may be appropriate for controller 56 to pulse supply valve 51 in such a way as to decrease the amount of urea introduced into the nozzle assembly. Further, in an engine operating condition producing a higher concentration of exhaust constituents, it may be appropriate for controller 56 to pulse supply valve 51 in such a way to increase the amount of urea introduced into the nozzle assembly. When supply valve 51 is in a closed position, neither cooling nor injection may be possible.

The controller 56 may control the pulsing of the supply valve 51 in response to various inputs. For example, the controller 56 may receive a communication from an exhaust sensor (not shown) indicating a current concentration of constituents (such as NOx) in the exhaust gas system. In response to this signal, the controller 56 may alter the operation of the supply valve 51 to increase or decrease the flow or pressure of fluid supplied to the nozzle assembly 2. It is also contemplated that the controller may also use other inputs to control the pulsing of the supply valve 51, such as fluid supply level, exhaust gas temperature, or any other condition in which it would be beneficial to change the flow, pressure, and operation of the supply valve 51.

### INDUSTRIAL APPLICABILITY

The fluid-injecting system 82 may be fluidly connected to an exhaust outlet of, for example, a diesel engine or other power source 78 known in the art. The power source 78 may be used in any conventional application where a supply of power is required. For example, the power source 78 may be used to supply power to stationary equipment, such as power generators, or other mobile equipment, such as vehicles. Such vehicles may include, for example, automobiles, work machines (including those for on-road, as well as off-road use), and other heavy equipment.

As shown in FIG. 2, in an exemplary embodiment of the present disclosure, the disclosed nozzle assembly 2 may be used in combination with the fluid-injecting system 82 to assist in reducing exhaust constituents, such as NOx, from the exhaust flow. Further, the disclosed nozzle assembly 2 may be actively cooled to prolong its component life. Still further, the disclosed supply valve 51 may assist the nozzle assembly 2 in injecting metered amounts of fluid by providing a pulsing flow controlled by controller 56.

A flow of exhaust produced by the power source 78 may pass from the power source 78, through an energy extraction assembly 80, and into the fluid-injecting system 82. It is understood that in an exemplary embodiment of the present disclosure, the energy extraction assembly 80 may be omitted. Under normal power source operating conditions, the fluid-injecting system 82 may introduce a metered amount of fluid into the exhaust flow, and the flow of exhaust may pass through the fluid-injecting system 82 to the catalyst substrate 84, where a portion of the constituents carried by the exhaust may react with the injected fluid. In addition to reacting with the constituents in the exhaust flow, the fluid solution may be used to cool portions of the nozzle assembly 2 after an injection cycle is complete

The operation of the nozzle assembly 2 will now be described in detail with respect to FIG. 1, unless otherwise noted.

To begin injecting fluid using the nozzle assembly 2, the controller 56 may substantially open the valves 40, 51. The first and second fluid passages 18, 16 may be supplied with fluid from the pump 44 via supply valve 51 at a predetermined pressure. It is understood that the fluid may be directed through the fluid line 50 and through supply valve 51 to the channels 52, 54 via fluid line 57 at substantially the same pressure. Thus, when the valve 40 is substantially open, the third fluid passage 28 may be at a low pressure relative to the first fluid passage 18. Such a pressure differential may direct the fluid to flow from the first fluid passage 18 in the direction of arrow 70 through the first radial passage 21, and into the third fluid passage 28. Once the fluid reaches the third fluid passage 28, the fluid may flow in the direction of arrow 68 through the open valve 40, and to the tank 42 via the fluid line 46. The fluid contained in the tank 42 may be at, for example, approximately atmospheric pressure. Because of the conical restriction 15, when the valve 40 is substantially open, fluid entering the first fluid passage 18 may not be capable of building up backpressure between the first radial passage 21 and the third fluid passage 28. More particularly, when the valve 40 is substantially open, fluid may not be capable of acting on the end 13 of the shaft 10.

The amount of fluid injected by the nozzle assembly 2 may assist in controlling, for example, the concentration of injected fluid within the fluid-injecting system 82 and the amount of constituents reduced thereby. As the supply valve 51 is controlled to approach a substantially fully open position while the valve 40 is substantially open, the amount of fluid injected by the nozzle assembly 2 may increase. In addition, when the supply valve 51 is in the relatively open position and the valve 40 is substantially open, fluid may enter the second fluid passage 16 and may pass in the direction of arrow 62 to the channel 24 of the housing 4, through the slots 36 and may enter the chamber 14. The fluid may enter the chamber 14 at an angle based on the configuration of the slots 36 and may exit the orifice 12 in a conical direction as illustrated by arrows 72. Thus, a fluid pressure may build up in the chamber 14 proximate the tip 11 of the shaft 10. This built-up fluid pressure may be less than the pressure of the fluid at channels 52, 54 and greater than, for example, the pressure of the fluid flowing through the first radial passage 21. In particular, the built-up pressure in the chamber 14 may be greater than the pressure of the fluid disposed in the first radial passage 21. As a result, the shaft 10 may be biased in the direction of arrow 74 to the open position shown in FIG. 1, and the delivery of fluid between the end 13 of the shaft 10 and the stop 30 may be substantially cut off. Although the fluid may be supplied to the second fluid passage 16 at a predetermined pressure, the pressure of the fluid in chamber 14 may be less than that predetermined pressure due to pressure losses upstream of the chamber 14.

When shaft 10 is in the open position, the amount of fluid provided to the fluid-injecting system 82 (FIG. 2) may be controlled by the supply valve 51 and the shaft 10 may remain in the open position as long as the fluid pressure at the tip 11 of the shaft 10 is greater than the fluid pressure acting on the end 13 of the shaft 10 and/or the stop 30. During injection, a portion of the pressurized fluid in the chamber 14 may also be desirably removed from a central portion of the chamber 14 by the feed holes 17. The feed holes 17 may assist in delivering the removed fluid to the bypass passage 22 of the shaft 10 and this flow of removed fluid may assist in, for example, cooling components of the nozzle assembly 2 during injection. It is understood that the fluid delivered by the slots 36 may be made to swirl within the chamber 14 due to, for example, the pressure and/or the angle relative to the longitudinal axis 9 and the radial axis 99 at which the fluid is delivered. The fluid swirling proximate the central portion of the chamber 14 may have less kinetic energy than fluid swirling proximate an outer surface of the chamber 14, and may remain approximately stationary relative to the central portion of the chamber 14. Thus, removing fluid from the central portion of the chamber 14 through the feed holes 17 may minimize the disruption of the swirling fluid within the chamber 14.

In addition, it is understood that during extended fluid injection processes, components of the nozzle assembly 2 may reach, for example, approximately 600 degrees Celsius or more. Thus, if fluid were to remain within components of the nozzle assembly 2, such as, for example, the slots 36 of the sleeve 8, at such elevated temperatures for extended periods of time, the fluid may begin to evaporate and/or corrode the components. Such evaporation and/or corrosion may clog the passages of such components and may reduce, for example, the effectiveness and/or the useful life of the nozzle assembly 2. Continuously cycling fluid through the components of the nozzle assembly 2 while the shaft 10 is in either the open or closed positions may reduce evaporation and/or corrosion and assist in extending the life of the nozzle assembly 2.

To stop injecting fluid into the fluid-injecting system 82 by moving shaft 10 to a closed position, the controller 56 may close the valve 40 and the supply valve 51 may remain in the relatively open position discussed above. When the valve 40 is closed, fluid may be directed to the first fluid passage 18 at, for example, approximately 250 psi by the pump 44. The fluid may collect within, for example, the first fluid passage 18 and the first radial passage 21, and fluid disposed within the first radial passage 21 of the sleeve 8 will act on the end 13 of the shaft 10. This fluid may have a fluid pressure that is substantially equal to the pressure of the fluid entering the first fluid passage 18 (i.e., approximately 250 psi). Thus, the pressure of the fluid acting on the end 13 of the shaft 10 may be greater than the pressure of the built-up fluid acting on the tip 11 of the shaft 10 when the valve 40 is closed and the supply valve 51 is in the relatively open position. This pressure differential may force the shaft 10 to move in the direction of arrow 76 until the tip 11 of the shaft 10 engages the orifice 12 of the cap 6. The shaft 10 may form a fluid seal with the cap 6 such that substantially no fluid may exit the orifice 12. As discussed above, when the shaft 10 is biased fully in the direction of arrow 76, the nozzle assembly 2 may be in the closed position.

In addition, while the nozzle assembly 2 is in the closed position as described above, the fluid entering the second fluid passage 16 may travel through the channel 24 in the direction of arrow 76. The fluid may pass through the slots 36 to the sealed chamber 14. The fluid may then be directed to the bypass passage 22 through the feed holes 17, and may travel through the escape channels 23 in the direction of arrow 64. The fluid may then enter the second radial passage 20 and exit the housing 4 through the fourth fluid passage 26 in the direction of arrow 66. The fluid may pass out of nozzle assembly 2 through fluid line 48 to the low pressure tank 42. As described above with respect to the open position of FIG. 1, when the nozzle assembly 2 is in the closed position, the fluid traveling through the slots 36, into the bypass passage 22, and around the second radial passage 21 may cool at least a portion of the nozzle assembly 2. Such cooling may reduce the level of evaporation and/or other corrosion-related reactions within the nozzle assembly 2. In addition, circulating fluid through the components of the nozzle assembly 2 while the fluid-injecting system 82 (FIG. 2) is not in use may reduce the build-up of dirt or other pollutants within the components.

Moreover, the supply valve 51 may be utilized in conjunction with the valve 40 to provide different modes of operation for the nozzle assembly 2. When valve 40 is substantially open, the shaft 10 is biased in the direction of arrow 74 to an open position, allowing fluid through bypass passage 22 and escape channels 23, out fourth fluid passage 26, and into tank 42 via fluid line 48, at least partially cooling the nozzle assembly 2. In this configuration, with valve 40 substantially open, supply valve 51 may be controlled by to achieve a relatively closed position, cutting off the feed of pressurized fluid from pump 44 to channels 52, 54 and effectively stopping the fluid injection and self-cooling action. Furthermore, supply valve 51 may be closed when valve 40 is also closed to cease cooling. Alternatively, supply valve 51 may be controlled by controller 56 to achieve a relatively open position, fluidly connecting fluid lines 50, 57 and directing the pressurized fluid supplied by pump 44 to channels 52, 54, allowing the nozzle assembly 2 to be in a fluid-injecting mode, and allowing the fluid to flow through bypass passage 22 and escape channels 23 through fourth fluid passage 26, which may at least partially cool the nozzle assembly 2. The supply valve 51 may also be controlled by controller 56 to rapidly change state from a substantially closed position to a substantially open position. This pulsing of the supply valve 51 by the controller 56 may allow amounts of fluid to be metered and supplied to nozzle assembly 2 in discrete intervals and at differing flows and pressures which in turn may allow nozzle assembly 2 to perform multiple discrete consecutive injection events while the valve 40 stays in a substantially same position.

Thus, operation of supply valve 51 may cause the nozzle assembly 2 to be in a mode of both injecting and cooling or a mode of not injecting and not cooling. Supply valve 51 alone may not be capable of providing a mode of not injecting but cooling. If supply valve 51 is in an open position, valve 40 may also be in an open position, causing the nozzle assembly 2 to be in a mode of injecting and cooling, or valve 40 may be in a closed position, thereby causing the nozzle assembly 2 to be in a mode of not injecting but still cooling. Further, if supply valve 51 is in a closed position, valve 40 may not be capable of providing either mode. If supply valve 51 is in an open position, valve 40 may not be able to stop the cooling function of nozzle assembly 2 provided via bypass passage 22.

It will be apparent to those having ordinary skill in the art that various modifications and variations can be made to the disclosed nozzle assembly 2 without departing from the scope of the invention. For example, although the nozzle assembly 2 is disclosed herein as having multiple distinct components, it is understood that one or more of the distinct components, such as, for example, the sleeve 8 and the stop 30, may be combined to form a single component. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A fluid-injecting system, comprising:
a nozzle assembly, including:
a housing defining an outlet cooling passage, an outlet control passage, at least one inlet supply passageway, and an injection orifice;
a shaft disposed within the housing and movable between a closed position at which fluid is prevented from exiting via the orifice and an open position at which fluid passes through the orifice;
a first valve in fluid communication with the nozzle assembly to regulate the supply of a fluid though the at least one inlet supply passageway; and
a second valve in fluid communication with the nozzle assembly to regulate a flow of fluid through the outlet control passageway.

2. The fluid-injecting system of claim 1, wherein the first valve in fluid communication with the nozzle assembly is a pulsing valve, located upstream of the nozzle assembly, and configured to vary the flow and pressure of the fluid supply within the nozzle assembly.

3. The fluid-injecting system of claim 2, wherein the pulsing valve is controlled in response to an engine operating condition.

4. The fluid-injecting system of claim 1, wherein the fluid is a mixture of urea and water.

5. The fluid-injecting system of claim 1, wherein:
the second valve, when in a closed position, allows the nozzle assembly to be in an injecting mode;
when in an open position, the second valve allows the nozzle to be in a non-injecting mode; and
both injecting and non-injecting modes maintain a self cooling function.

6. The fluid-injecting system of claim 1, wherein:
the first valve, when in an open position, allows the nozzle assembly to be in an injecting and self-cooling mode; and
when in a closed position, the first valve allows the nozzle to be in a non-injecting and non-self cooling mode.

7. The fluid-injecting system of claim 1, wherein:
the at least one inlet includes a first and second passageway;
the first passageway is in fluid communication with the first outlet fluid passage; and
the second passageway is in fluid communication with the second outlet fluid passageway and the orifice.

8. The fluid-injecting system of claim 7, wherein the shaft defines a bypass passage fluidly connecting the orifice and the second outlet fluid passageway.

9. The fluid-injecting system of claim 7, wherein the shaft defines a bypass passage configured to communicate a fluid between the one inlet fluid passageway and the first outlet fluid passage.

10. The fluid-injecting system of claim 1, further including a sleeve disposed within the housing and around the shaft, wherein the sleeve further includes a plurality of slots fluidly connected to the at least one inlet fluid passage and the slots are configured to direct a fluid into a chamber of the nozzle assembly at relative to a longitudinal axis of the shaft when the shaft is in the open position.

11. The fluid-injecting system of claim 10, wherein the shaft defines at least one feed hole in fluid communication with the chamber.

12. An exhaust treatment system, comprising:
a fluid-injecting system configured to inject a water/urea mixture upstream of the catalyst substrate, the fluid injecting system comprising:
a nozzle assembly, including:
a housing defining a first outlet fluid passage, a second outlet fluid passage, at least one inlet fluid passageway, and an orifice; and
a shaft disposed within the housing and movable between a closed position at which fluid is prevented from exiting via the orifice and an open position at which fluid passes through the at least one orifice;
a first valve in fluid communication with the nozzle assembly to regulate the supply of a fluid though the at least one inlet fluid passageway; and
a second valve in fluid communication with the nozzle assembly to regulate a flow of fluid through the first outlet fluid passageway; and
a catalyst substrate disposed downstream of the fluid-injecting system.

13. The exhaust treatment system of claim 12, wherein the fluid is a mixture of urea and water.

14. The exhaust treatment system of claim 12, wherein the first valve in fluid communication with the nozzle assembly is a pulsing valve, located upstream of the nozzle assembly, and configured to vary the flow and pressure of the fluid supply within the nozzle assembly.

15. The exhaust treatment system of claim 12, wherein the sleeve further includes a plurality of slots configured to direct a fluid from the second fluid passage to a chamber of the nozzle assembly.

16. A method of injecting reductant comprising:
supplying the reductant to a nozzle assembly;
regulating the supply rate of reductant to the nozzle assembly;
draining a portion of the reductant supplied to the nozzle assembly; and
regulating a rate of reductant draining from the nozzle assembly to initiate injections of reductant.

17. The method of claim 16, wherein the fluid is a mixture of urea and water.

18. The method of claim 16, further including:
utilizing a portion of supplied reductant to cool the nozzle assembly; and
draining the portion of the supplied reductant utilized to cool separate from the flow regulated to initiate injection.

19. The method of claim 16, further including supplying the reductant to a nozzle assembly in pulses.

20. The method of claim 16, further including swirling the fluid within the nozzle assembly.
